(19) United States
(12) Patent Application Publication
(10) Pub. No.: US 2025/0148290 A1
(43) Pub. Date: May 8, 2025

(54) OBJECTIVE SELECTION FOR LLM-BASED NETWORK TROUBLESHOOTING AND MONITORING AGENTS

(71) Applicant: Cisco Technology, Inc., San Jose, CA (US)

(72) Inventors: Jean-Philippe Vasseur, Combloux (FR); Pierre-André SAVALLE, Rueil-Malmaison (FR); Grégory MERMOUD, Venthône (CH); Eduard SCHORNIG, Haarlem (NL)

(21) Appl. No.: 18/386,833

(22) Filed: Nov. 3, 2023

(51) Int. Cl. G06N 3/09

(52) U.S. Cl. CPC G06N 3/09

(57) ABSTRACT

In one implementation, a device receives an input request for a large language model-based troubleshooting agent for a network. The device selects an optimization criterion for the large language model-based troubleshooting agent based on the input request. The device provides the optimization criterion to the large language model-based troubleshooting agent to cause the large language model-based troubleshooting agent to select a particular large language model to process the input request based on the optimization criterion. The device sends, to a user interface, an indication of a result of the particular large language model processing the input request.

### TECHNICAL FIELD

The present disclosure relates generally to objective selection for large language model (LLM)-based network troubleshooting and monitoring agents.

### BACKGROUND

The recent breakthroughs in large language models (LLMs), such as ChatGPT and GPT-4, represent new opportunities across a wide spectrum of industries. More specifically, the ability of these models to follow instructions now allow for interactions with tools (also called plugins) that are able to perform tasks such as searching the web, executing code, etc. In addition, agents can be written to perform complex tasks by chaining multiple calls to one or more LLMs. For example, a first step can consist in formulating a plan in natural language, and subsequent steps in executing on this plan by writing code to call application programming interfaces (APIs) or libraries.

As of today, LLMs handle a vast array of tasks via the use of prompts that are subject to various engineering strategies (also known as prompt engineering). However, despite attempts to interpret how LLMs work and the outcomes they produce, LLMs are largely black boxes and techniques to influence their optimization criterion is still an area of study. For instance, in the case of an LLM-based troubleshooting and monitoring agent, various optimization criteria can be tuned such as speed (trying to reduce the response time), accuracy (reducing the number of incorrect replies and hallucination), cost (trying to reduce the prompt's size, or the cost to run model inference), etc. However, selecting the optimal set of objectives is no simple task, as different use cases and scenarios may require different objectives. In addition, even when the decoding strategy can be customized using parameters such as “temperature” to indicate to the LLM the degree of randomness or “creativity” of the model in its output, these parameters only have a moderate impact on the objectives listed above.

### BRIEF DESCRIPTION OF THE DRAWINGS

The implementations herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIGS. 3A-3B illustrate example network deployments;

FIG. 4 illustrates an example software defined network (SDN) implementation;

FIG. 5 illustrates an example architecture for objective selection for large language model (LLM)-based network troubleshooting and monitoring agents;

FIG. 6 illustrates the operation of the components of the architecture of FIG. 5 to troubleshoot a network; and

FIG. 7 illustrates an example simplified procedure for objective selection for LLM-based network troubleshooting and monitoring agents.

### DESCRIPTION OF EXAMPLE IMPLEMENTATIONS

### Overview

According to one or more implementations of the disclosure, a device receives an input request for a large language model-based troubleshooting agent for a network. The device selects an optimization criterion for the large language model-based troubleshooting agent based on the input request. The device provides the optimization criterion to the large language model-based troubleshooting agent to cause the large language model-based troubleshooting agent to select a particular large language model to process the input request based on the optimization criterion. The device sends, to a user interface, an indication of a result of the particular large language model processing the input request.

### Description

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

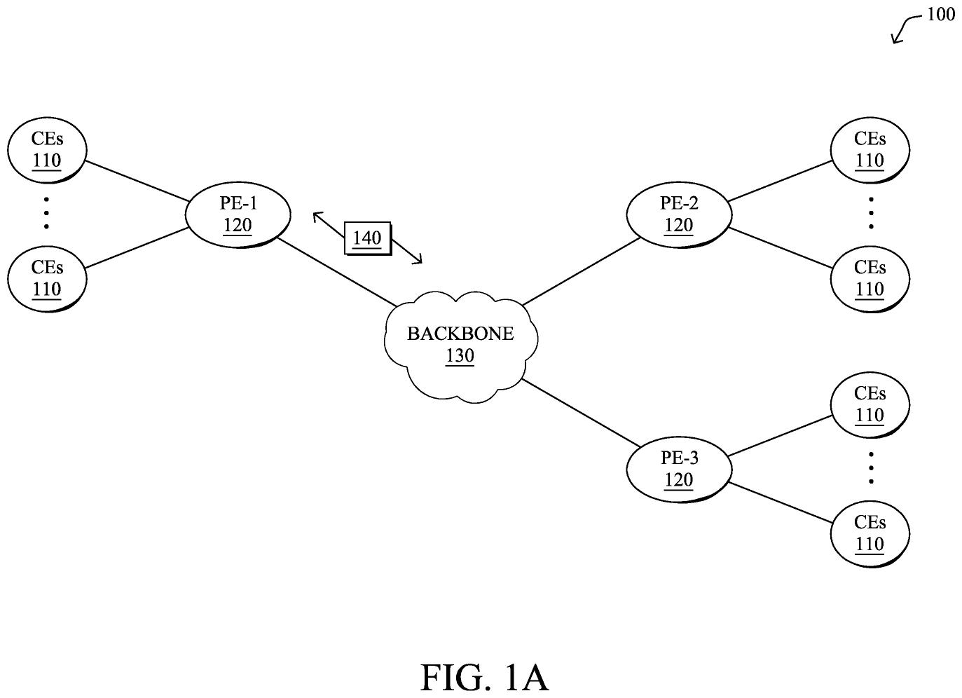

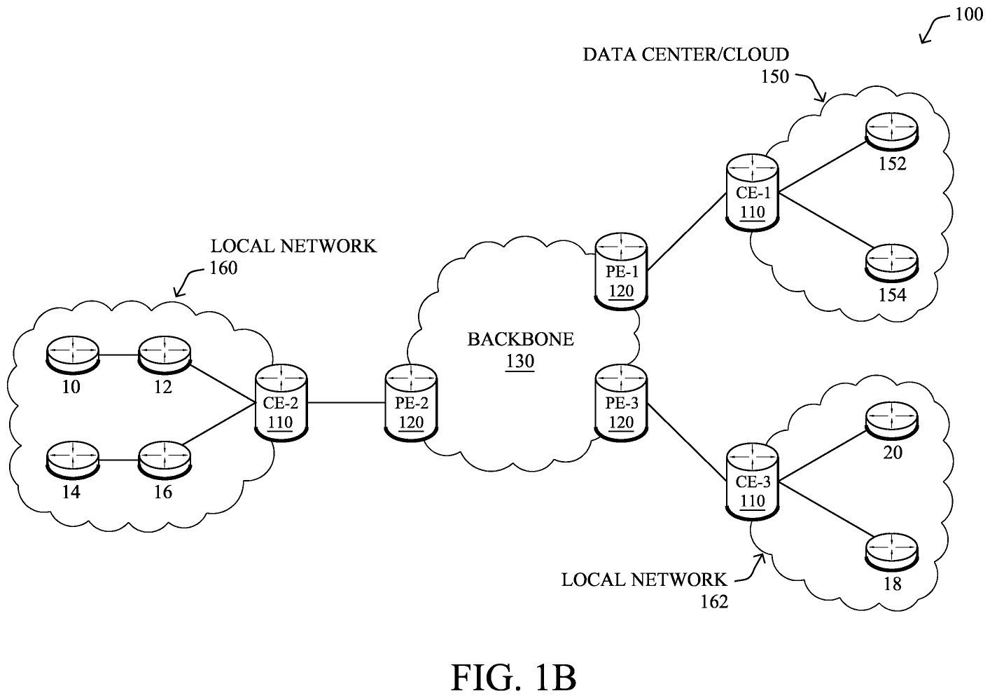

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:
1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.
2.) Site Type B: a site connected to the network by the CE router via two primary links (e.g., from different Service Providers), with potentially a backup link (e.g., a 3G/4G/5G/LTE connection). A site of type B may itself be of different types:
2a.) Site Type B1: a site connected to the network using two MPLS VPN links (e.g., from different Service Providers), with potentially a backup link (e.g., a 3G/4G/5G/LTE connection).
2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.
2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).
3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various implementations. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various implementations, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some implementations, the techniques herein may be applied to other network topologies and configurations. For example, the techniques herein may be applied to peering points with high-speed links, data centers, etc.

According to various implementations, a software-defined WAN (SD-WAN) may be used in network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

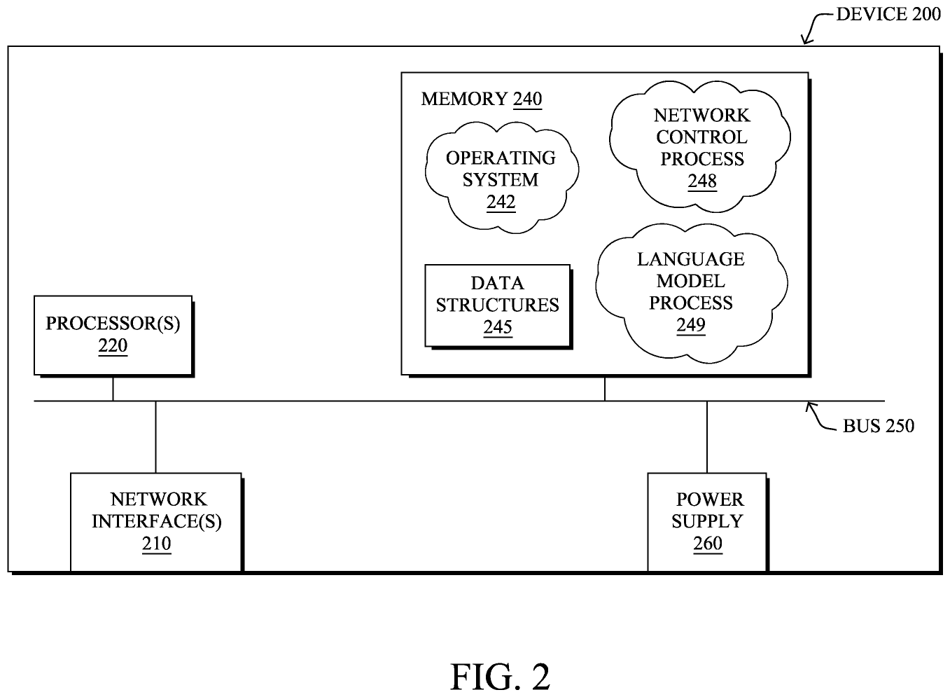

FIG. 2 is a schematic block diagram of an example node/device 200 (e.g., an apparatus) that may be used with one or more implementations described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software components may comprise a network control process 248 and/or a language model process 249 as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In some instances, network control process 248 may include computer executable instructions executed by the processor 220 to perform routing functions in conjunction with one or more routing protocols. These functions may, on capable devices, be configured to manage a routing/forwarding table (a data structure 245) containing, e.g., data used to make routing/forwarding decisions. In various cases, connectivity may be discovered and known, prior to computing routes to any destination in the network, e.g., link state routing such as Open Shortest Path First (OSPF), or Intermediate-System-to-Intermediate-System (ISIS), or Optimized Link State Routing (OLSR). For instance, paths may be computed using a shortest path first (SPF) or constrained shortest path first (CSPF) approach. Conversely, neighbors may first be discovered (e.g., a priori knowledge of network topology is not known) and, in response to a needed route to a destination, send a route request into the network to determine which neighboring node may be used to reach the desired destination. Example protocols that take this approach include Ad-hoc On-demand Distance Vector (AODV), Dynamic Source Routing (DSR), DYnamic MANET On-demand Routing (DYMO), etc. Notably, on devices not capable or configured to store routing entries, network control process 248 may consist solely of providing mechanisms necessary for source routing techniques. That is, for source routing, other devices in the network can tell the less capable devices exactly where to send the packets, and the less capable devices simply forward the packets as directed.

In various implementations, as detailed further below, network control process 248 and/or language model process 249 may include computer executable instructions that, when executed by processor(s) 220, cause device 200 to perform the techniques described herein. To do so, in some implementations, network control process 248 and/or language model process 249 may utilize machine learning. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, network control process 248 and/or language model process 249 may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that network control process 248 and/or language model process 249 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, network control process 248 and/or language model process 249 may also include one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of network assurance, network control process 248 may use a generative model to generate synthetic network traffic based on existing user traffic to test how the network reacts. Example generative approaches can include, but are not limited to, generative adversarial networks (GANs), large language models (LLMs), other transformer models, and the like.

The performance of a machine learning model can be evaluated in a number of ways based on the number of true positives, false positives, true negatives, and/or false negatives of the model. For example, consider the case of a model that predicts whether the QoS of a path will satisfy the service level agreement (SLA) of the traffic on that path. In such a case, the false positives of the model may refer to the number of times the model incorrectly predicted that the QoS of a particular network path will not satisfy the SLA of the traffic on that path. Conversely, the false negatives of the model may refer to the number of times the model incorrectly predicted that the QoS of the path would be acceptable. True negatives and positives may refer to the number of times the model correctly predicted acceptable path performance or an SLA violation, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

As noted above, in software defined WANs (SD-WANs), traffic between individual sites are sent over tunnels. The tunnels are configured to use different switching fabrics, such as MPLS, Internet, 4G or 5G, etc. Often, the different switching fabrics provide different QoS at varied costs. For example, an MPLS fabric typically provides high QoS when compared to the Internet, but is also more expensive than traditional Internet. Some applications requiring high QoS (e.g., video conferencing, voice calls, etc.) are traditionally sent over the more costly fabrics (e.g., MPLS), while applications not needing strong guarantees are sent over cheaper fabrics, such as the Internet.

Traditionally, network policies map individual applications to Service Level Agreements (SLAs), which define the satisfactory performance metric(s) for an application, such as loss, latency, or jitter. Similarly, a tunnel is also mapped to the type of SLA that is satisfies, based on the switching fabric that it uses. During runtime, the SD-WAN edge router then maps the application traffic to an appropriate tunnel. Currently, the mapping of SLAs between applications and tunnels is performed manually by an expert, based on their experiences and/or reports on the prior performances of the applications and tunnels.

The emergence of infrastructure as a service (IaaS) and software-as-a-service (SaaS) is having a dramatic impact of the overall Internet due to the extreme virtualization of services and shift of traffic load in many large enterprises. Consequently, a branch office or a campus can trigger massive loads on the network.

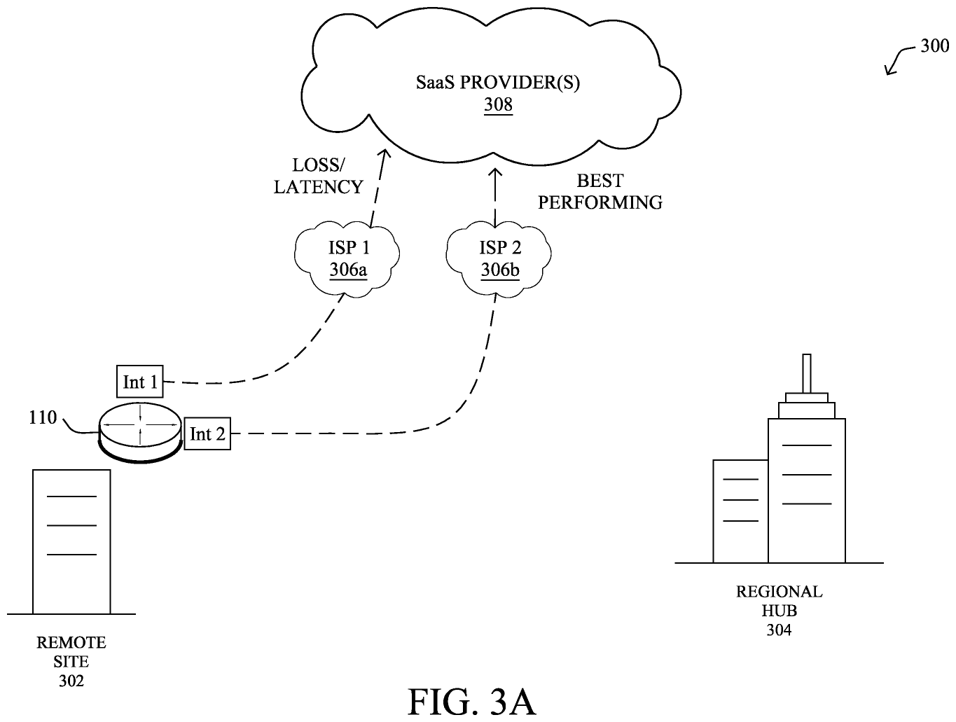

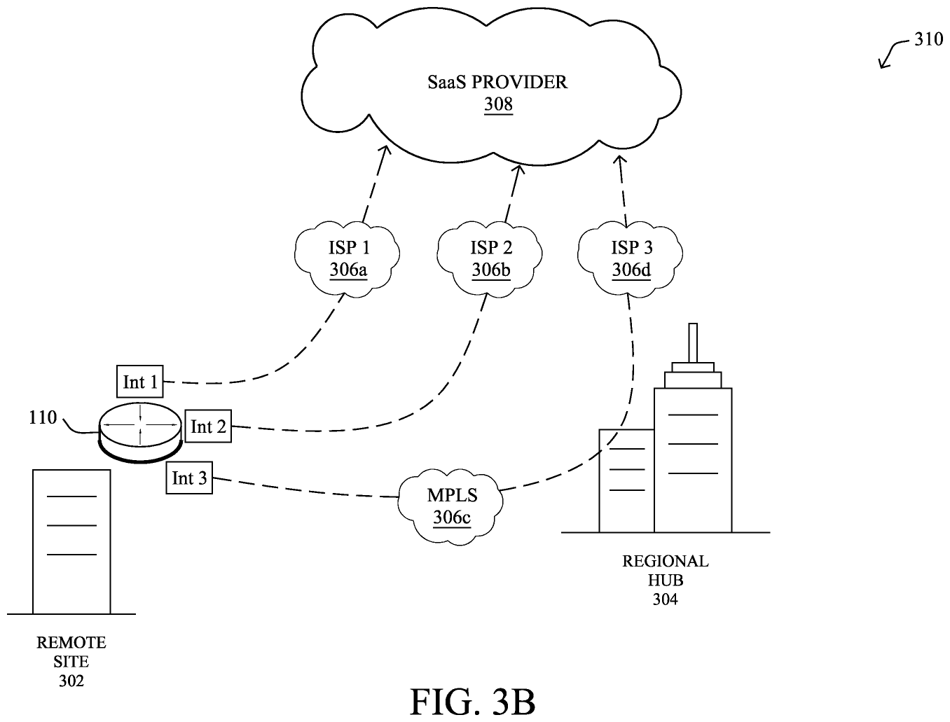

FIGS. 3A-3B illustrate example network deployments 300, 310, respectively. As shown, a router 110 located at the edge of a remote site 302 may provide connectivity between a local area network (LAN) of the remote site 302 and one or more cloud-based, SaaS providers 308. For example, in the case of an SD-WAN, router 110 may provide connectivity to SaaS provider(s) 308 via tunnels across any number of networks 306. This allows clients located in the LAN of remote site 302 to access cloud applications (e.g., Office 365™, Dropbox™, etc.) served by SaaS provider(s) 308.

As would be appreciated, SD-WANs allow for the use of a variety of different pathways between an edge device and an SaaS provider. For example, as shown in example network deployment 300 in FIG. 3A, router 110 may utilize two Direct Internet Access (DIA) connections to connect with SaaS provider(s) 308. More specifically, a first interface of router 110 (e.g., a network interface 210, described previously), Int 1, may establish a first communication path (e.g., a tunnel) with SaaS provider(s) 308 via a first Internet Service Provider (ISP) 306a, denoted ISP 1 in FIG. 3A. Likewise, a second interface of router 110, Int 2, may establish a backhaul path with SaaS provider(s) 308 via a second ISP 306b, denoted ISP 2 in FIG. 3A.

FIG. 3B illustrates another example network deployment 310 in which Int 1 of router 110 at the edge of remote site 302 establishes a first path to SaaS provider(s) 308 via ISP 1 and Int 2 establishes a second path to SaaS provider(s) 308 via a second ISP 306b. In contrast to the example in FIG. 3A, Int 3 of router 110 may establish a third path to SaaS provider(s) 308 via a private corporate network 306c (e.g., an MPLS network) to a private data center or regional hub 304 which, in turn, provides connectivity to SaaS provider(s) 308 via another network, such as a third ISP 306d.

Regardless of the specific connectivity configuration for the network, a variety of access technologies may be used (e.g., ADSL, 4G, 5G, etc.) in all cases, as well as various networking technologies (e.g., public Internet, MPLS (with or without strict SLA), etc.) to connect the LAN of remote site 302 to SaaS provider(s) 308. Other deployments scenarios are also possible, such as using Colo, accessing SaaS provider(s) 308 via Zscaler or Umbrella services, and the like.

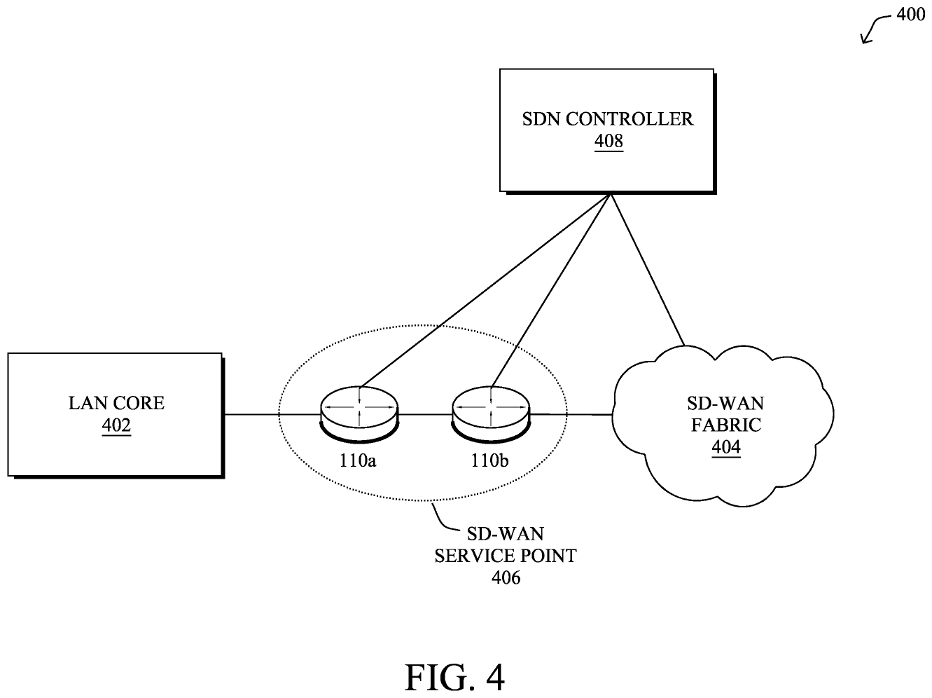

FIG. 4 illustrates an example SDN implementation 400, according to various implementations. As shown, there may be a LAN core 402 at a particular location, such as remote site 302 shown previously in FIGS. 3A-3B. Connected to LAN core 402 may be one or more routers that form an SD-WAN service point 406 which provides connectivity between LAN core 402 and SD-WAN fabric 404. For instance, SD-WAN service point 406 may comprise routers 110a-110b.

Overseeing the operations of routers 110a-110b in SD-WAN service point 406 and SD-WAN fabric 404 may be an SDN controller 408. In general, SDN controller 408 may comprise one or more devices (e.g., a device 200) configured to provide a supervisory service (e.g., through execution of network control process 248), typically hosted in the cloud, to SD-WAN service point 406 and SD-WAN fabric 404. For instance, SDN controller 408 may be responsible for monitoring the operations thereof, promulgating policies (e.g., security policies, etc.), installing or adjusting IPsec routes/tunnels between LAN core 402 and remote destinations such as regional hub 304 and/or SaaS provider(s) 308 in FIGS. 3A-3B, and the like.

As noted above, a primary networking goal may be to design and optimize the network to satisfy the requirements of the applications that it supports. So far, though, the two worlds of “applications” and “networking” have been fairly siloed. More specifically, the network is usually designed in order to provide the best SLA in terms of performance and reliability, often supporting a variety of Class of Service (CoS), but unfortunately without a deep understanding of the actual application requirements. On the application side, the networking requirements are often poorly understood even for very common applications such as voice and video for which a variety of metrics have been developed over the past two decades, with the hope of accurately representing the Quality of Experience (QoE) from the standpoint of the users of the application.

More and more applications are moving to the cloud and many do so by leveraging an SaaS model. Consequently, the number of applications that became network-centric has grown approximately exponentially with the raise of SaaS applications, such as Office 365, ServiceNow, SAP, voice, and video, to mention a few. All of these applications rely heavily on private networks and the Internet, bringing their own level of dynamicity with adaptive and fast changing workloads. On the network side, SD-WAN provides a high degree of flexibility allowing for efficient configuration management using SDN controllers with the ability to benefit from a plethora of transport access (e.g., MPLS, Internet with supporting multiple CoS, LTE, satellite links, etc.), multiple classes of service and policies to reach private and public networks via multi-cloud SaaS.

Furthermore, the level of dynamicity observed in today's network has never been so high. Millions of paths across thousands of Service Provides (SPs) and a number of SaaS applications have shown that the overall QoS(s) of the network in terms of delay, packet loss, jitter, etc. drastically vary with the region, SP, access type, as well as over time with high granularity. The immediate consequence is that the environment is highly dynamic due to:
New in-house applications being deployed;
New SaaS applications being deployed everywhere in the network, hosted by a number of different cloud providers;
Internet, MPLS, LTE transports providing highly varying performance characteristics, across time and regions;
SaaS applications themselves being highly dynamic: it is common to see new servers deployed in the network. DNS resolution allows the network for being informed of a new server deployed in the network leading to a new destination and a potentially shift of traffic towards a new destination without being even noticed.

According to various implementations, SDN controller 408 may employ application aware routing, which refers to the ability to route traffic so as to satisfy the requirements of the application, as opposed to exclusively relying on the (constrained) shortest path to reach a destination IP address. For instance, SDN controller 408 may make use of a high volume of network and application telemetry (e.g., from routers 110a-110b, SD-WAN fabric 404, etc.) so as to compute statistical and/or machine learning models to control the network with the objective of optimizing the application experience and reducing potential down times. To that end, SDN controller 408 may compute a variety of models to understand application requirements, and predictably route traffic over private networks and/or the Internet, thus optimizing the application experience while drastically reducing SLA failures and downtimes.

In other words, SDN controller 408 may first predict SLA violations in the network that could affect the QoE of an application (e.g., due to spikes of packet loss or delay, sudden decreases in bandwidth, etc.). In other words, SDN controller 408 may use SLA violations as a proxy for actual QoE information (e.g., ratings by users of an online application regarding their perception of the application), unless such QoE information is available from the provider of the online application. In turn, SDN controller 408 may then implement a corrective measure, such as rerouting the traffic of the application, prior to the predicted SLA violation. For instance, in the case of video applications, it now becomes possible to maximize throughput at any given time, which is of utmost importance to maximize the QoE of the video application. Optimized throughput can then be used as a service triggering the routing decision for specific application requiring highest throughput, in one implementation. In general, routing configuration changes are also referred to herein as routing “patches,” which are typically temporary in nature (e.g., active for a specified period of time) and may also be application-specific (e.g., for traffic of one or more specified applications),

As noted above, the recent breakthroughs in large language models (LLMs), such as ChatGPT and GPT-4, represent new opportunities across a wide spectrum of industries. More specifically, the ability of these models to follow instructions now allow for interactions with tools (also called plugins) that are able to perform tasks such as searching the web, executing code, etc.

In the specific context of computer networks, though, network troubleshooting and monitoring are traditionally complex tasks that rely on engineers analyzing telemetry data, configurations, logs, and events across a diverse array of network devices encompassing access points, firewalls, routers, and switches managed by various types of network controllers (e.g., SD-WAN, DNAC, ACI, etc.). Moreover, network issues can manifest in various forms, stemming from a multitude of factors, each with its own level of complexity.

The introduction of plugins is a major development that enables LLM-based agents to interact with external systems and empower new domain-specific use cases. In the context of communication networks, the utilization of plugins allows LLMs to engage with documentation repositories, tap into knowledge bases, and interface with live network controllers and devices potentially opening the path to LLMs undertaking more complex tasks such as on-demand troubleshooting, device configuration, and performance monitoring. In addition, agents can be written to perform complex tasks by chaining multiple calls to one or more LLMs. For example, a first step can consist in formulating a plan in natural language, and subsequent steps in executing on this plan by writing code to call application programming interfaces (APIs) or libraries.

However, building a user-facing product from an LLM-based agent can be difficult for reasons such as the following:
An agent flow to answer a question may require multiple steps, each of which can take some time, individually. Consequently, the system may take a noticeable amount of time to provide an answer to the original question (e.g., on the order of minutes), which can be frustrating to users.
LLMs can make mistakes which may not be apparent to a user. For example, consider the case of an LLM that can generate code that calls an API to list network devices but somehow provides an incorrect filter argument to the API. When the API returns an empty result set, a user may interpret this result as meaning that no devices match their desired criteria while, in fact, the system simply called the API incorrectly. These issues can be hard to avoid due to the opaque and non-deterministic nature of LLMs, and users may quickly lose confidence in the system when faced with such issues.
Although LLMs can provide an alternative user experience by allowing a user to ask questions about a system using natural language, users often have years of familiarity with traditional web or application user interfaces. A chat bot can feel like a disconnected experience from those user interfaces, which can also be frustrating to users.

As of today, LLMs handle a vast array of tasks via the use of prompts that are subject to various engineering strategies (also known as prompt engineering). However, despite attempts to interpret how LLMs work and the outcomes they produce, LLMs are largely black boxes and techniques to influence their optimization criterion is still an area of study. For instance, in the case of an LLM-based troubleshooting and monitoring agent, various optimization criteria can be tuned such as speed (trying to reduce the response time), accuracy (reducing the number of incorrect replies and hallucination), cost (trying to reduce the prompt's size, or the cost to run model inference), etc. However, selecting the optimal set of objectives is no simple task, as different use cases and scenarios may require different objectives. In addition, even when the decoding strategy can be customized using parameters such as “temperature” to indicate to the LLM the degree of randomness or “creativity” of the model in its output, these parameters only have a moderate impact on the objectives.

### Objective Selection for LLM-Based Network Troubleshooting and Monitoring Agents

The techniques herein introduce an LLM-based troubleshooting and monitoring system capable of optimizing for one or more optimization criteria, per category of request, according to either an API or policy engine. In some aspects, optimization criteria are used as input to the system to perform model selection with specific characteristics (speed, inference cost, number of parameters and thus efficacy), tune the prompt accordingly, or the like. In further aspects, a global dashboard may report the overall performance in light of the optimization criteria in order to determine whether new models should be trained, whether knowledge databases should be used, optimizations strategies to use, whether prompt engineering should be used, and/or the set of optimization criterion to be used by the LLM-based network troubleshooting and monitoring agent of the system.

Illustratively, the techniques described herein may be performed by hardware, software, and/or firmware, such as in accordance with language model process 249, which may include computer executable instructions executed by the processor 220 (or independent processor of interfaces 210) to perform functions relating to the techniques described herein, such as in conjunction with network control process 248.

Specifically, according to various implementations, a device receives an input request for a large language model-based troubleshooting agent for a network. The device selects an optimization criterion for the large language model-based troubleshooting agent based on the input request. The device provides the optimization criterion to the large language model-based troubleshooting agent to cause the large language model-based troubleshooting agent to select a particular large language model to process the input request based on the optimization criterion. The device sends, to a user interface, an indication of a result of the particular large language model processing the input request.

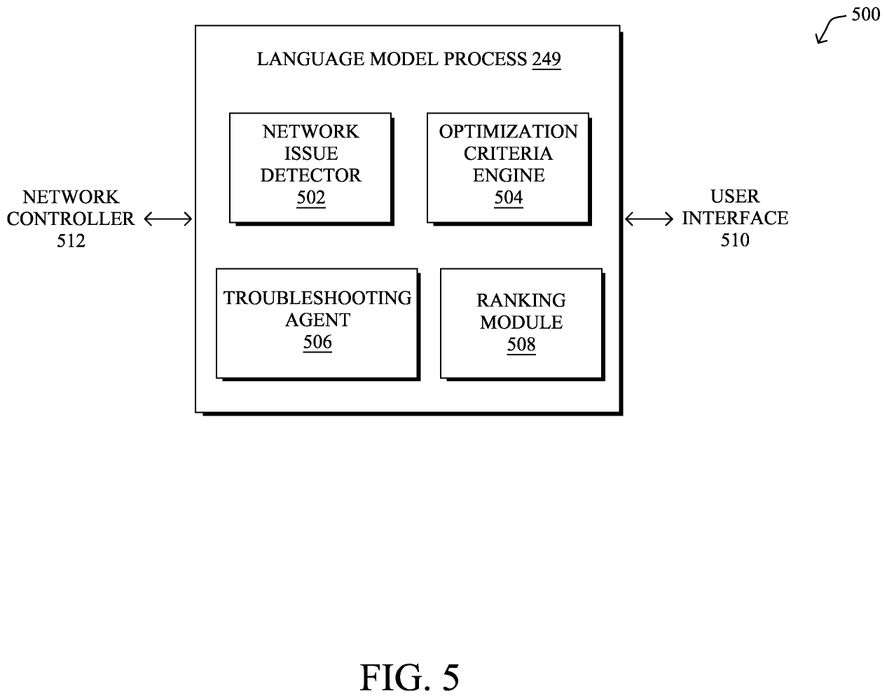

Operationally, FIG. 5 illustrates an example architecture 500 for objective selection for large language model (LLM)-based network troubleshooting and monitoring agents, according to various implementations. At the core of architecture 500 is language model process 249, which may be executed by a controller for a network or another device in communication therewith. For instance, language model process 249 may be executed by a controller for a network (e.g., SDN controller 408 in FIG. 4, a network controller in a different type of network, etc.), a particular networking device in the network (e.g., a router, a firewall, etc.), another device or service in communication therewith, or the like. For instance, as shown, language model process 249 may interface with a network controller 512, either locally or via a network, such as via one or more application programming interfaces (APIs), etc.

As shown, language model process 249 may include any or all of the following components: a network issue detector 502, an optimization criteria engine 504, a troubleshooting agent 506, and/or a ranking module 508. As would be appreciated, the functionalities of these components may be combined or omitted, as desired. In addition, these components may be implemented on a singular device or in a distributed manner, in which case the combination of executing devices can be viewed as their own singular device for purposes of executing language model process 249.

During execution, network issue detector 502 may detect an issue in a network and assess its criticality. To do so, network issue detector 502 may employ any number of modes for the issue detection. In one case, network issue detector 502 may rely on a set of issues eligible for analysis by troubleshooting agent 506 (e.g. detection of a link/router down, congestion thresholds for a given link layer, trigger of a recovery mechanism such as IGP/FRR, automated network tests or probes failing). In another case, network issue detector 502 may detect an issue based on information from a (troubleshooting) bot receiving requests from a set of users, in which case the issue can be created on-the-fly, if the number/rate of requests related to (a specific type of) issue exceeds a given threshold. For instance, a user may issue a question via user interface 510 such as “why is my Internet connection slow?”

Once network issue detector 502 has detected an issue I, it may then determine the criticality of that issue. To that end, one option may consist in checking the number of potential users who raised a similar issue that share the same root cause according to the root causing process initiated by troubleshooting agent 506, as described below, or its LLM may also be used to determine whether the issues raised by the users have a common root cause. In other cases, an LLM may determine criticality based on the number of impacted systems or applications or the volume of affected network traffic.

In various implementations, optimization criteria engine 504 may specify the optimization criteria for the request sent to troubleshooting agent 506 regarding a particular issue detected by network issue detector 502. In one implementation, optimization criteria engine 504 may be controlled via an API. In other implementations, optimization criteria engine 504 may include a policy engine used to set the optimization parameter(s) for troubleshooting agent 506 such as any or all of the following:
Cost (e.g., reduce the cost, thus the total number of tokens in the prompt(s) for all requests generated to solve a given task T)
Efficacy refers to the quality of the task resolution (e.g., the percentage of times the task was successfully solved, the percentage of hallucinations, etc.)
Speed refers to the end-to-end time between the request and the final answer by troubleshooting agent 506. As shown in the figure above, time can greatly vary between tasks.
Determinism is also a key attribute that may be critical for specific task where it might be highly undesirable to get different answers and trajectories of action ai for a given task T. In this context, a “trajectory” refers to a set of successive actions ai triggered by troubleshooting agent 506 according to the LLM input.

The metrics specified above may be Boolean (1: Yes, 0: No) or expressed as a preference (from x to y). Moreover, they may be mutually exclusive or not. By way of example:
Boolean/Exclusive: Cost: 1, Reliability: 0, Speed: 0, Determinism: 0
Boolean/non-exclusive: Cost: 1, Reliability: 0, Speed: 1, Determinism: 0
Continuous/non-Exclusive: Cost: 9, Reliability: 2, Speed: 5, Determinism: 1

An implementation may also support a subset of the potential combinations for the optimization criterion. Of course, some combinations may also drastically increase the overall complexity and cost to maintain troubleshooting agent 506, in some cases.

According to various implementations, troubleshooting agent 506 may leverage one or more LLMs to troubleshoot an issue identified by network issue detector 502, find the actual root cause for the issue, and/or suggest a set of one or more actions to fix the issue (potentially implementing the actions, as well). Let ai denote an action used for troubleshooting an issue I and let Ai denote an action (configuration change) on the network (closed-loop control). The set of actions Ai required to solve the issue I may be determined on-the-fly by an LLM, statically determined according to a cookbook for each trajectory made of a set of action ai, or the like. For example, a static cookbook may be used to map a specific ak to set of actions Ak,l. Consider the action ak=“Check the priority queue length of a router,” a static set of action ak,l may be used to trigger a set of l action on the network (e.g., “Change the weight of the priority queue,” “Modify the WRED parameter for the high priority queue”). In another implementation, the system may discover the set of required actions related to a given root cause identified thanks to a set of action ai, using reinforcement learning or another suitable approach.

If the root cause identified for issue I is eligible for automated resolution, troubleshooting agent 506 may perform any or all of the following:
Troubleshooting agent 506 retrieves the set of action Ai for the root cause of issue I after activating a timer T (max time to solve the issue)
Troubleshooting agent 506 may also employ various optimization criterion may be used for solving a given task T. For instance, troubleshooting agent 506 may solve some tasks with objective metrics such as reducing the processing time or improve accuracy even at the risk of involving more steps and tokens (cost). In the context of the techniques herein, the issue criticality from network issue detector 502 may also drive the optimization criteria (time versus reliability versus cost). In one implementation, the optimization criteria may be unique and decided according to policy and criticality. In another implementation, troubleshooting agent 506 may trigger multiple actions in parallel, each with different optimization criterion. For example, for a given issue I, troubleshooting agent 506 may send a request to a first LLM with a first criteria (e.g., solve as quickly as possible, optimizing time) and send the same request to a second LLM with different optimization criteria (e.g., efficiency). In such a case, troubleshooting agent 506 may use the reply to the first request (set of resolution action Ai) to quickly fix the network, followed by using the second set of actions to optimize the resolution of the issue. Note that both requests may not overlap in terms of closed-loop actions, as well.

More specifically, in various implementations, optimization criteria engine 504 may operate in conjunction with troubleshooting agent 506 to optimize the selection of the LLM model used by troubleshooting agent 506 to address a given issue, as well as the one or more optimization criteria associated with that issue.

By way of example, let Mi(C) represent the set of available LLM models where C is the optimization criterion. A given LLM model Mi may be optimized for one or more optimization criteria. For example, if C=“Cost,” optimization criteria engine 504 may try to compress the size of the prompt for the LLM or may even not use any prompt but a model trained/optimized to solve the task T with its limited (backed-in) knowledge (e.g., a model that does not require a heavy prompt). Such an approach may require a large enough LLM model that has been trained with a large dataset, thus requiring less knowledge embedded in the prompt. The model size may be medium (with enough parameters and thus memory but not too large should the cost of inference also be a critical parameter). Additionally, optimization criteria engine 504 may limit the number of LLM API calls to avoid too many of these calls, at the risk of not solving the task T and thus with a potentially lower Efficacy. If C=“Efficiency” the selected model may be even larger (thus more costly at inference). If C=“Determinism, optimization criteria engine 504 may set the temperature for troubleshooting agent 506 to a lower value and constrained to non-diverse trajectories. Access to the decoding loop may also be used to constrain the outcome even more, thus improving determinism. Note that there might also be a negative impact on cost and speed. If non-exclusive optimization criteria are supported, troubleshooting agent 506 may further make use of LLM models with different sizes (thus different efficacy, cost, etc.) and leverage model performance metrics for each of those models that influence the optimization such as any or all of the following:
Efficacy—e.g., the percentage of successful test cases
Code score—e.g., 1/10 scoring of coding abilities
Response time—e.g., median time (in seconds) to obtain a response
Number of tokens—the average number of tokens consumed per case
Warning rate—the fraction of cases that raised a warning (e.g., due to incorrect formatting, etc.)
Method recall—the fraction of relevant methods found by semantic search

Another potential function of optimization criteria engine 504 interacting with troubleshooting agent 506 may entail prompt engineering, employing various such strategies, depending on C. For instance, if C=“Cost,” optimization criteria engine 504 may compress the prompt size as much as possible using a highly optimized LLM (fine-tuned for a specific task). In another example, if C=“Efficacy,” then a larger amount of the data may be added to the prompt using Retrieval Augmentation Generation (RAG) from a knowledge database (a large set of information will be retrieved from the knowledge database), while allowing for the use of large models.

In further implementations, troubleshooting agent 506 may also perform request management, adding additional constraints according to the optimization criterion, as needed. For example, troubleshooting agent 506 may limit the number of interactions with the selected LLM(s) in order to increase Speed at the risk of reducing Efficacy. The set of APIs selected may also be constrained by C: should reliability be critical, troubleshooting agent 506 may select only reliable APIs.

Additionally, the various performance metrics may be reported by troubleshooting agent 506 for each set of tasks and used to adequately set optimization criteria engine 504. Indeed, after review, the network administrator may decide that tasks of a given category may be supported only for a subset of criterion (one or more criterion, potential exclusive). For example, a request of task category with C=“Cost” and “Efficiency” may not be supported because cost optimization has a too severe impact on Efficiency for such a task category with the current system.

In yet another embodiment, such a dashboard may also be used by the designer of troubleshooting agent 506 to decide that new models should be trained (or hyper-parameters of existing models should be modified). Moreover, the dashboard could also be used to modify the knowledge database structure and semantic search according to the set of supported optimization criterion.

Optionally, ranking module 508 may operate to rank various combinations of LLM model selected, prompt engineering methodology, and request management parameters for a set of test questions or tasks in a representative environment. For instance, ranking module 508 may compute a matrix of results (cost, efficacy, speed, determinism) that optimization criteria engine 504 can use to determine the best combination of parameters for a given task or set of tasks and optimization objective or objectives. Combinations that may not meet a minimum absolute threshold for any of the objectives can be excluded from the matrix. As new LLM models or prompt engineering methodologies are developed, they can be added to the matrix and evaluated against the existing combinations.

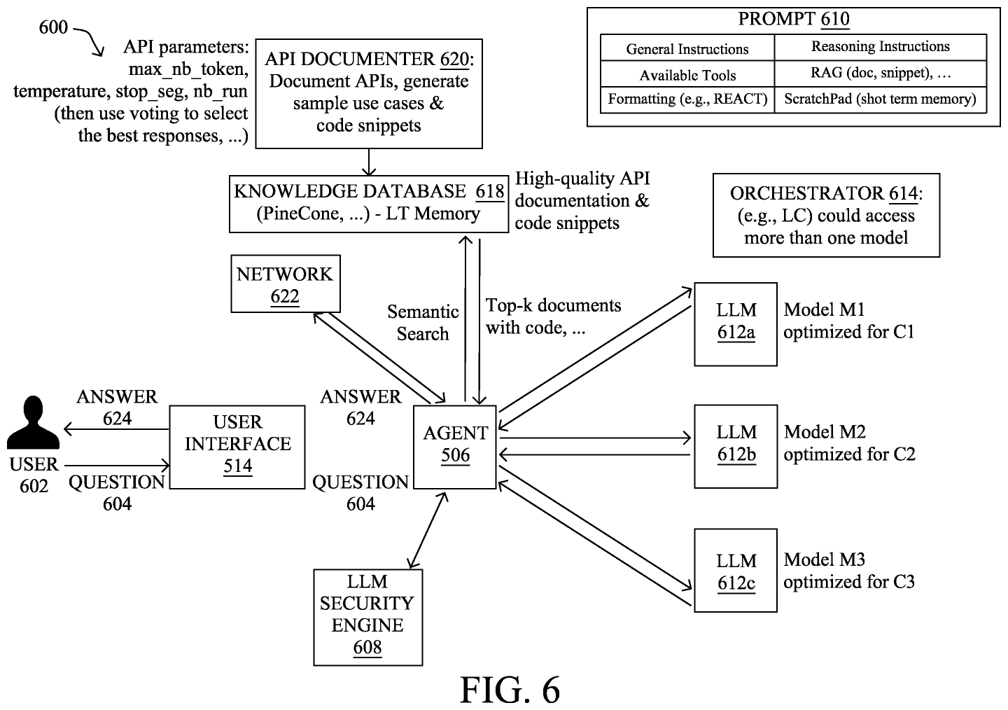

FIG. 6 illustrates an example 600 showing the operation of the components of architecture 500 with respect to a network 622, according to various implementations. As shown, troubleshooting agent 506 may interact with one or more LLMs 612, such as LLMs 612a-612c shown, to perform troubleshooting and monitoring in network 622. These LLMs may be integrated directly into troubleshooting agent 506 or accessed by troubleshooting agent 506 remotely, such as via an API. In some implementations, each of these LLMs may have different capabilities, as well. For instance, LLM 612a may be optimized for optimization criterion C1, LLM 612b may be optimized for optimization criterion C2, and LLM 612c may be optimized for optimization criteria C3. Of course, C1-C3 may also represent sets of multiple criteria, as well. In some instances, troubleshooting agent 506 may also leverage an intermediary orchestrator 614 that can access one or more of the LLMs, such as LLMs 612a-612c.

Assume now that a user 602 enters a question 604 via user interface 510 regarding network 622. Note that while such input typically takes the form of a question, mere statements such as “my network connection is slow, etc.” are also equally possible inputs. In such cases, question 604 may be treated by the system (e.g., network issue detector 502) as a raised issue for assessment by troubleshooting agent 506. To do so, troubleshooting agent 506 may seek to answer question 604 by interacting with network 622, interacting with a knowledge database 618 populated by an API documenter 620 (e.g., by performing a semantic search for API formats, code snippets, sample use cases, or the like), and/or by issuing a prompt 610 for input to any of LLMs 612. Note that prompt 610 may also indicate general instructions and/or reasoning instructions, to obtain information regarding an action. In some instances, an LLM security engine 608 may also oversee the actions of troubleshooting agent 506, to prevent conditions such as prompt injection attacks, etc.

Here, optimization criteria engine 504 may operate to specify the optimization criterion/criteria on the fly used by troubleshooting agent 506 to resolve the issue associated with question 604. For instance, optimization criteria engine 504 may specify optimization criteria to troubleshooting agent 506 to perform LLM model selection with specific characteristics (e.g., speed, inference cost, number of parameters and thus efficacy), tune the prompt accordingly (with or without RAG using knowledge database 618, with more or less information in the prompt, etc.).

In some cases, troubleshooting agent 506 may also implement one or more actions in network 622 indicated by the selected LLM 612. For instance, troubleshooting agent 506 may send a command to a network controller of network 622 (e.g., via an API) to reconfigure the network to address any issues. In turn, troubleshooting agent 506 may provide an answer 624 back to user interface 510 to answer question 604 (e.g., “your connection was slow because of a misconfiguration—please let us know if the issue has been resolved,” etc.). In other instances, troubleshooting agent 506 may forego initiating automatic resolution of the issue and simply notify user 602 and/or an administrator as to the issue and action(s) needed to resolve it.

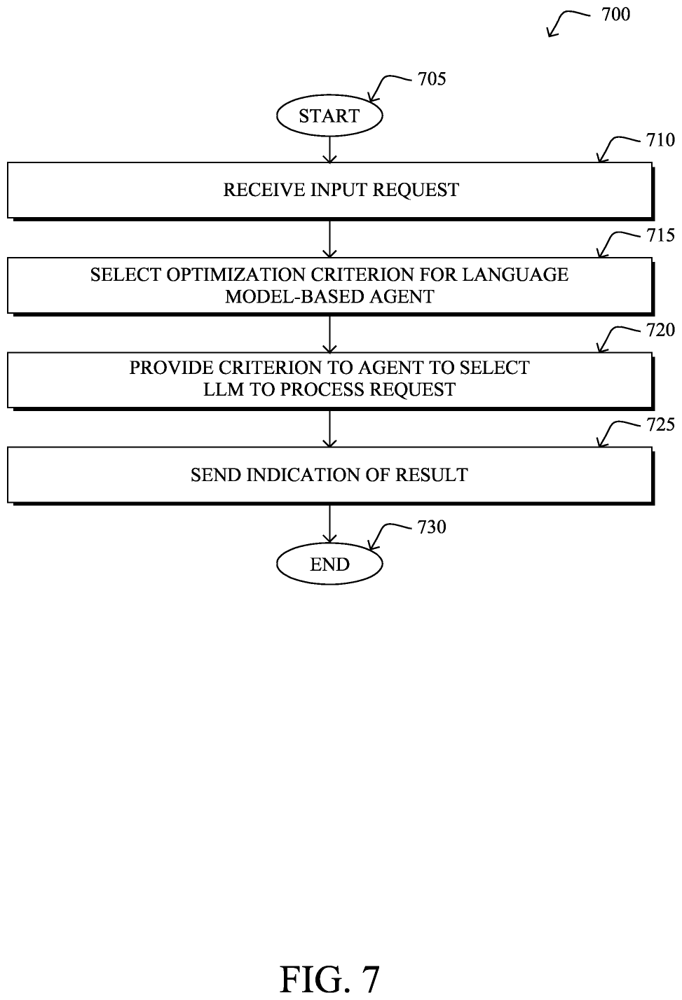

FIG. 7 illustrates an example simplified procedure (e.g., a method) for objective selection for large language model (LLM)-based network troubleshooting and monitoring agents, in accordance with one or more implementations described herein. For example, a non-generic, specifically configured device (e.g., device 200), such as a router, firewall, controller for a network (e.g., an SDN controller or other device in communication therewith), server, or the like, may perform procedure 700 by executing stored instructions (e.g., language model process 249 and/or network control process 248). The procedure 700 may start at step 705, and continues to step 710, where, as described in greater detail above, the device may receive an input request for an LLM-based troubleshooting agent for a network. In some cases, the input request indicates an issue in the network for the LLM-based troubleshooting agent to troubleshoot.

At step 715, as detailed above, the device selects an optimization criterion for the LLM-based troubleshooting agent based on the input request. In one instance, the optimization criterion indicates that the LLM-based troubleshooting agent should minimize a number of tokens sent by the LLM-based troubleshooting agent to the particular LLM. In another instance, the optimization criterion indicates that the LLM-based troubleshooting agent should select the particular LLM based on it having a highest degree of efficacy from among a set of available LLMs. In a further implementation, the optimization criterion indicates that the LLM-based troubleshooting agent should select the particular LLM based on it having a highest degree of processing speed from among a set of available LLMs. In one implementation, the device selects the optimization criterion based on a criticality associated with the input request.

At step 720, the device may provide the optimization criterion to the LLM-based troubleshooting agent to cause the LLM-based troubleshooting agent to select a particular LLM to process the input request based on the optimization criterion, as described in greater detail above. In various implementations, the optimization criterion causes the LLM-based troubleshooting agent to generate one or more prompts for the particular LLM to satisfy the optimization criterion. In another implementation, the optimization criterion limits a number of actions between the LLM-based troubleshooting agent and the particular LLM to process the input request. In another instance, the optimization criterion indicates a degree of determinism that controls a level of randomness of the particular LLM.

At step 725, as described in greater detail above, the device may send, to a user interface, an indication of a result of the particular LLM processing the input request. In addition, the device may also provide performance metrics for the particular LLM for review by an administrator.

Procedure 700 then ends at step 730.

It should be noted that while certain steps within procedure 700 may be optional as described above, the steps shown in FIG. 7 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative implementations that provide for objective selection for large language model (LLM)-based network troubleshooting and monitoring agents, it is to be understood that various other adaptations and modifications may be made within the spirit and scope of the implementations herein. For example, while certain implementations are described herein with respect to using certain models for purposes of generating CLI commands, making API calls, charting a network, and the like, the models are not limited as such and may be used for other types of predictions, in other implementations. In addition, while certain protocols are shown, other suitable protocols may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

1. A method comprising:
receiving, at a device, an input request for a large language model-based troubleshooting agent for a network;
selecting, by the device, an optimization criterion for the large language model-based troubleshooting agent based on the input request;
providing, by the device, the optimization criterion to the large language model-based troubleshooting agent to cause the large language model-based troubleshooting agent to select a particular large language model to process the input request based on the optimization criterion; and
sending, by the device and to a user interface, an indication of a result of the particular large language model processing the input request.

2. The method as in claim 1, wherein the optimization criterion indicates that the large language model-based troubleshooting agent should minimize a number of tokens sent by the large language model-based troubleshooting agent to the particular large language model.

3. The method as in claim 1, wherein the optimization criterion indicates that the large language model-based troubleshooting agent should select the particular large language model based on it having a highest degree of efficacy from among a set of available large language models.

4. The method as in claim 1, wherein the optimization criterion indicates that the large language model-based troubleshooting agent should select the particular large language model based on it having a highest degree of processing speed from among a set of available large language models.

5. The method as in claim 1, wherein the optimization criterion causes the large language model-based troubleshooting agent to generate one or more prompts for the particular large language model to satisfy the optimization criterion.

6. The method as in claim 1, wherein the optimization criterion limits a number of actions between the large language model-based troubleshooting agent and the particular large language model to process the input request.

7. The method as in claim 1, wherein the optimization criterion indicates a degree of determinism that controls a level of randomness of the particular large language model.

8. The method as in claim 1, wherein the input request indicates an issue in the network for the large language model-based troubleshooting agent to troubleshoot.

9. The method as in claim 1, wherein the device selects the optimization criterion based on a criticality associated with the input request.

10. The method as in claim 1, further comprising:
providing, by the device, performance metrics for the particular large language model for review by an administrator.

11. An apparatus, comprising:
one or more network interfaces;
a processor coupled to the one or more network interfaces and configured to execute one or more processes; and
a memory configured to store a process that is executable by the processor, the process when executed configured to:
receive an input request for a large language model-based troubleshooting agent for a network;
select an optimization criterion for the large language model-based troubleshooting agent based on the input request;
provide the optimization criterion to the large language model-based troubleshooting agent to cause the large language model-based troubleshooting agent to select a particular large language model to process the input request based on the optimization criterion; and
send, to a user interface, an indication of a result of the particular large language model processing the input request.

12. The apparatus as in claim 11, wherein the optimization criterion indicates that the large language model-based troubleshooting agent should minimize a number of tokens sent by the large language model-based troubleshooting agent to the particular large language model.

13. The apparatus as in claim 11, wherein the optimization criterion indicates that the large language model-based troubleshooting agent should select the particular large language model based on it having a highest degree of efficacy from among a set of available large language models.

14. The apparatus as in claim 11, wherein the optimization criterion indicates that the large language model-based troubleshooting agent should select the particular large language model based on it having a highest degree of processing speed from among a set of available large language models.

15. The apparatus as in claim 11, wherein the optimization criterion causes the large language model-based troubleshooting agent to generate one or more prompts for the particular large language model to satisfy the optimization criterion.

16. The apparatus as in claim 11, wherein the optimization criterion limits a number of actions between the large language model-based troubleshooting agent and the particular large language model to process the input request.

17. The apparatus as in claim 11, wherein the optimization criterion indicates a degree of determinism that controls a level of randomness of the particular large language model.

18. The apparatus as in claim 11, wherein the input request indicates an issue in the network for the large language model-based troubleshooting agent to troubleshoot.

19. The apparatus as in claim 11, wherein the apparatus selects the optimization criterion based on a criticality associated with the input request.

20. A tangible, non-transitory, computer-readable medium storing program instructions that cause a device to execute a process comprising:
receiving, at the device, an input request for a large language model-based troubleshooting agent for a network;
selecting, by the device, an optimization criterion for the large language model-based troubleshooting agent based on the input request;
providing, by the device, the optimization criterion to the large language model-based troubleshooting agent to cause the large language model-based troubleshooting agent to select a particular large language model to process the input request based on the optimization criterion; and
sending, by the device and to a user interface, an indication of a result of the particular large language model processing the input request.
